(19) United States
(12) Patent Application Publication
(10) Pub. No.: US 2008/0168492 A1
(43) Pub. Date: Jul. 10, 2008

(54) Celestial Viewing System With Video Display

(75) Inventors: Kenneth Baun, Trabuco Canyon, CA (US); John LaBelle, Long Beach, CA (US); Brian Tingey, Fountain Valley, CA (US); John Hoot, San Clemente, CA (US); Steve Szczuka, Chino Hills, CA (US); Jeff Rucker, Del Mar, CA (US)

Correspondence Address: INSKEEP INTELLECTUAL PROPERTY GROUP, INC, 2281 W. 190TH STREET, SUITE 200, TORRANCE, CA, 90504, US

(73) Assignee: Meade Instruments Corp.

(21) Appl. No.: 11/691,442

(22) Filed: Mar. 26, 2007

Related U.S. Application Data
(60) Provisional application No. 60/883,743, filed on Jan. 5, 2007.

(51) Int. Cl. H04N 9/475

(52) U.S. Cl. 725/37; 348/E05.009

(57) ABSTRACT

In a preferred embodiment, a control unit is provided for controlling a motorized telescope system and displaying video content or media. The video media may include positional data that directs the motorized telescope system to observe a predetermined celestial object or location at a predetermined time during media playback. In this respect, the control unit is especially suitable for providing, for example, guided video tours of the sky, instructional videos supplemented by real world viewing, games, and video calibration instructions for the motorized telescope system.

### RELATED APPLICATIONS

This application claims priority to U.S. Provisional Application Ser. No. 60/883,743 filed Jan. 5, 2007 entitled Celestial Viewing System With Video Display which is hereby incorporated by reference.

### BACKGROUND OF THE INVENTION

The present invention relates to automated telescope systems and, more particularly, to systems and methods for aligning and orienting such automated telescope systems.

The continuing evolution of low cost, high performance integrated circuit processors has enabled the recent introduction of fully automated telescope systems which are capable of performing alignment and orientation operations under software program control with a minimum of intervention by a user. Telescope systems are able to perform alignment and orientation functions regardless of whether they might be configured as an alt-azimuth telescope or as an equatorial telescope. The system is provided with sufficient processing power and with a multiplicity of application routines, such that alignment and orientation is performed with regard to a large number of different algorithms and with respect to a variety of user definable data-type inputs.

Such telescope systems might be described as intelligent, in that they typically include a command module which is a fully functional microprocessor controlled command unit, capable of executing high level application software routines and performing numerous data processing tasks, such as numerical calculations, coordinate system transformations, database manipulations, and managing the functional performance of various different peripherally coupled devices.

Central interface panels might be provided on the telescope systems which support interconnection between and among various intelligent motor modules, command modules and peripheral devices. Communication between and among component parts is made over serial data and control communication channels in accordance with a packet-based serial communication protocol. An RS-232 port is also provided such that a command module is able to communicate with ancillary RS-232 capable devices such as personal computer systems.

Use of the various communication channels allows the telescope system to communicate with other devices in order to exchange stored information, exchange created and stored operating routines, obtain updates to programs and/or internal databases, and the like. In this regard, such computer systems include a number of internal databases, including at least one database of the celestial coordinates (RA and DEC) of known celestial objects that might be of interest to an observer. Further, the system might include a database of the geographical coordinates (latitude and longitude) of a large body of geographical landmarks. These landmarks might include known coordinates of cities and towns, carte graphic features such as mountains, and might also include the coordinates of any definable point on the earth's surface whose position is stable and geographically determinable. Each of the databases is user accessible such that additional entries of particular interest to a user might be included.

Distributed intelligence might be further characterized in that the telescope system hand-held command module might be provided in two separate configurations. The first configuration might be termed a simplified configuration, and might be functionally limited in that it is able to provide direction and speed commands to the intelligent motor modules, but might only be provided with limited operational command processing capabilities so as to offer a low-cost alternative. In this particular configuration, system intelligence would reside primarily in the motor modules, with the command module functioning more as a steering guidance control, or directional joystick. However, even given its reduced computational elegance, the simplified command module is nevertheless capable of executing a wide variety of command instructions including those relating to numerical processing and arithmetic calculations.

In particular, the solution to any given problem in celestial trigonometry depends on being able to convert measurements obtained in one coordinate system (Alt-Az, for example) into a second coordinate system (the celestial coordinate system). Performing such coordinate system transformations is well within the capability of limited functionality processors such as might be provided with a limited intelligence command module.

Accordingly, limited intelligence command modules should be able to support various alignment and orientation schemes so as to allow a simplified automated telescope system the ability to align and orient it self with respect to the celestial sphere and provide a relatively unsophisticated user with capability of, at least, tracking a designated viewing object throughout its determinable motion across the night sky.

While such basic tracking and viewing functionality may hold the interest of more experienced observers, casual and less experienced users may find these automated telescopes difficult to calibrate, difficult to find celestial objects, and less than interesting. Therefore a more sophisticated telescope system is needed which can better assist a user in complicated automated telescope calibration, can better assist a user find specific celestial objects and can make the astronomical viewing experience more interesting.

### OBJECTS AND SUMMARY OF THE INVENTION

It is an object of the present invention to overcome the limitations of the prior art.

It is an object of the present invention to provide celestial object viewing equipment with multimedia functionality.

It is a further object of the present invention to provide an automated telescope system capable of media playback.

It is yet a further object of the present invention to provide an automated telescope system capable of automated movement synchronized with playback of media content.

It is yet a further object of the present invention to provide a hand-held viewing device capable of media playback.

It is yet a further object of the present invention to provide a hand-held viewing device capable displaying orientation or directional data synchronized with playback of media content.

In a preferred embodiment of the present invention, a control unit is provided for controlling a motorized telescope system and displaying video content or media. The media may include positional data that directs the motorized telescope system to observe a predetermined celestial object or location at a predetermined time during media playback. In this respect, the control unit is especially suitable for providing, for example, guided video tours of the sky, instructional videos supplemented by real world viewing, games, and video calibration instructions for the motorized telescope system.

In another preferred embodiment of the present invention, a hand-held optical viewing device is provided for viewing celestial objects and displaying media content. The viewing device includes sensors that sense the position and orientation of the device, thereby allowing the device to determine the field of view of the user. The device can play media files that include orientation data which may direct the user to observe a specific celestial object at a predetermined time during media playback. Thus the viewing device is especially suitable for providing, for example, guided video tours of the sky, instructional videos and games.

### BRIEF DESCRIPTION OF THE DRAWINGS

FIG. 1 illustrates a perspective view of a control unit and automated telescope system according to a preferred embodiment of the present invention;

FIG. 2A illustrates a side view of the control unit of FIG. 1;

FIG. 2B illustrates a front view of the control unit of FIG. 1;

FIG. 2C illustrates a side view of the control unit of FIG. 1;

FIG. 2D illustrates a top view of the control unit of FIG. 1;

FIG. 2E illustrates a bottom view of the control unit of FIG. 1;

FIG. 2F illustrates a back perspective view of the control unit of FIG. 1;

FIG. 2G illustrates a front perspective view of the control unit of FIG. 1;

FIGS. 3A and 3B illustrate a schematic circuit diagram of a preferred embodiment of a control unit according to the present invention;

FIG. 4 illustrates a conceptual diagram of a method of transferring media according to a preferred embodiment of the present invention;

FIG. 5 illustrates a partially cut-away perspective view of a hand-held viewing device according to a preferred embodiment of the present invention;

FIGS. 6A and 6B illustrate a schematic circuit diagram of a hand-held viewing device according to a preferred embodiment of the present invention; and

FIGS. 7-9 illustrate various views of a media authoring software tool according to a preferred embodiment of the present invention.

### DETAILED DESCRIPTION OF THE INVENTION

In one aspect of the present invention, a control unit is provided for controlling a motorized telescope system and displaying video content or media. The media may include synchronized positional data that directs the motorized telescope system to observe a predetermined celestial object or location. In this respect, the control unit is especially suitable for providing, for example, guided video tours of the sky, instructional videos supplemented by real world viewing, promotional sales videos to help sell equipment in stores, games, product assembly and usage instructions and video calibration instructions for the motorized telescope system.

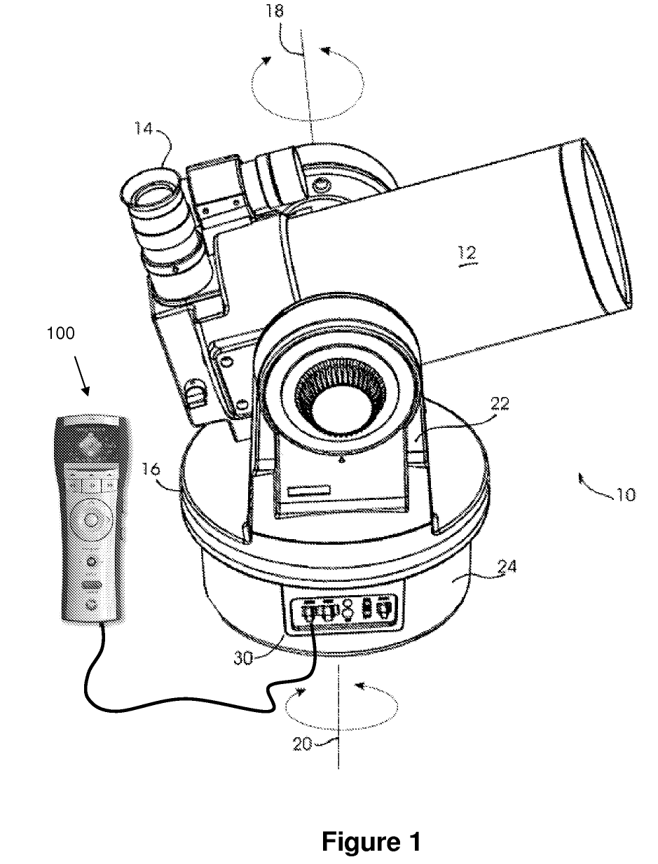

FIG. 1 illustrates an example of an automated telescope system 10 that can be used with the control unit 100 of the present invention. The telescope system 10 comprises a telescope tube 12 which houses the optical system required for resolving distant objects, including a focusing objective and eyepiece 14 coupled to the optical system in a manner to allow the observation of the optical system's focal plane. The telescope tube 12 is supported by a mount 16 which facilitates movement to the telescope tube 12 about two orthogonal axes, a substantially vertical axis, termed an altitude axis and a substantially horizontal axis, termed an azimuth axis. As those having skill in the art will appreciate, the horizontal and vertical axes of the mount 16 in combination, define a gimbaled support for the telescope tube 12 enabling it to pivot in a horizontal plane defined by the vertical (or altitude) axis and, independently, to pivot through a vertical plane defined by the horizontal (azimuth) axis.

It should be noted that telescope system 10 is illustrated as comprising a telescope tube 12 configured as a reflecting-type telescope, particularly a Maksutov-Cassegrain telescope. In this regard, the form of the telescope's optical system, per se is not particularly relevant to practice of principles of the present invention. Thus, even though depicted as a reflector, the telescope system 10 of the present invention is eminently suitable for use with refractor-type telescope optical systems. For example, the specific optical systems used might be Newtonian, Schmidt-Cassegrain, Maksutov-Cassegrain, or any other conventional reflecting or refracting optical system configured for telescopic use.

In the telescope system embodied in FIG. 1, it is convenient to support the telescope tube and mount combination in such a manner that the vertical axis 18 is, indeed, substantially vertical such that the telescope pivots (or rotates) about the vertical axis in the plane which is substantially horizontal. A tripod conventionally functions to support the mount 16 such that the altitude axis 18 is substantially orthogonal to a horizontal plane, relative to the user of a telescope system. The tripod is conventionally configured to include three supporting legs, which are arranged in a triangular pattern. Each of the legs are independently adjustable for leveling the mount 16 in order to conform to the nature of the surface upon which the telescope system 10 is used.

In addition to supporting telescope motion about two orthogonal axes, the mount 16 is constructed to include an electrical interface junction panel 30 which allows various electronic components, such as a control unit 100, to be interconnected and to support interoperability. The electrical interface junction panel 30 is configured to support upgradeability of the telescope system 10 to a fully intelligent automatic telescope system in a series of logically consistent steps, each of which results in a fully functional telescope system having a greater or lesser degree of intelligence and/or functionality, depending upon where, along the upgrade spectrum, a user would achieve the most subjectively desirable ratio of system complexity as a function of functional benefit.

Additional details of automated telescope systems can be seen in U.S. Pat. Nos. 5,311,203; 6,304,376; 6,369,942; 6,392,799; 6,563,636; 6,922,283; 7,079,317; and 7,092,156. The contents of these patents are hereby incorporated by reference.

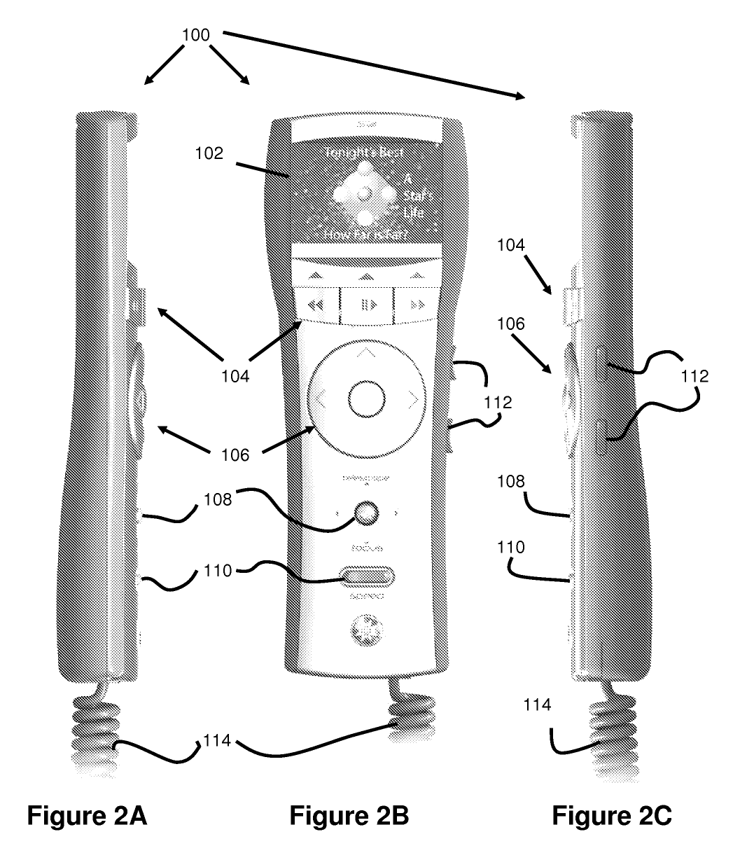

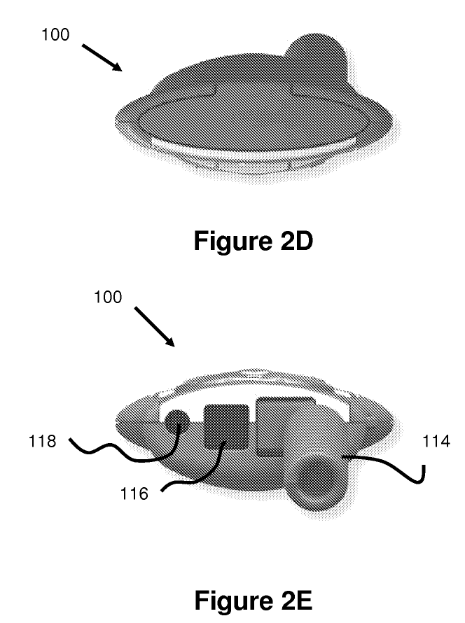

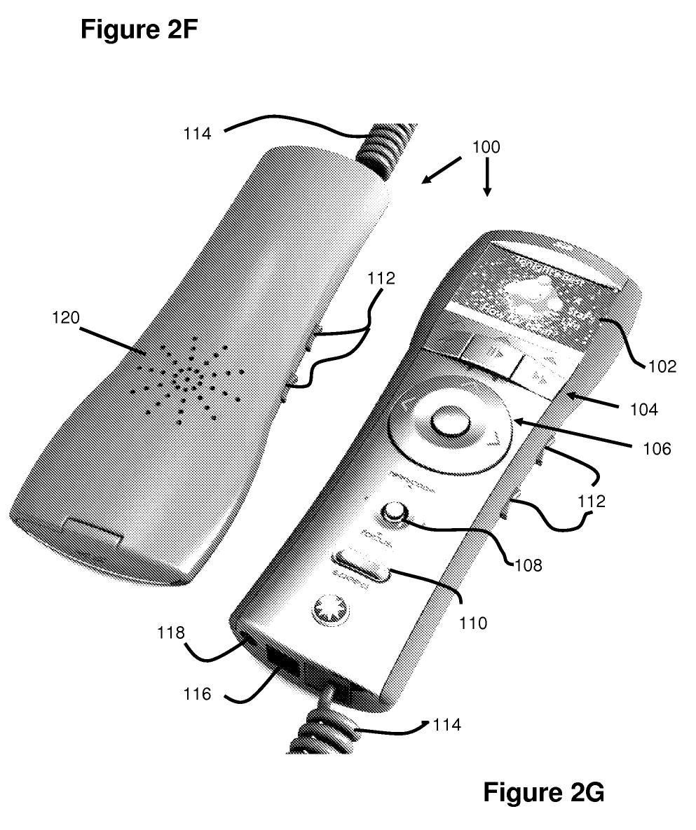

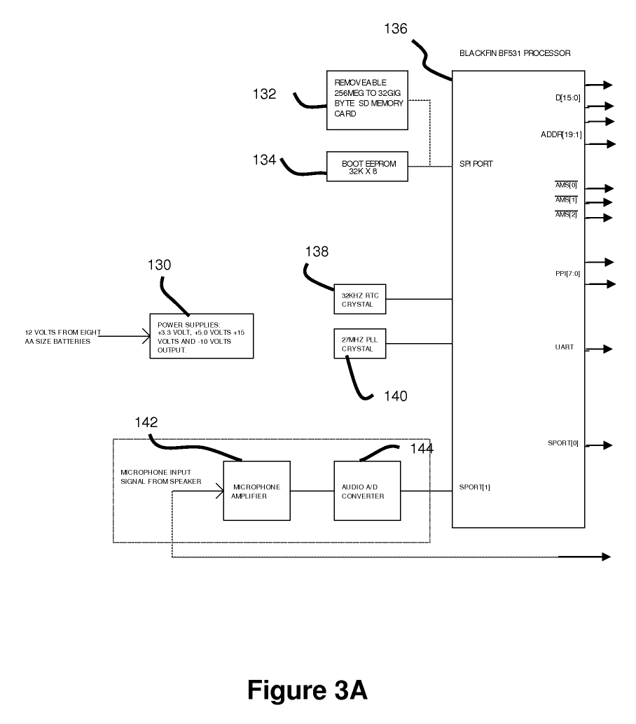

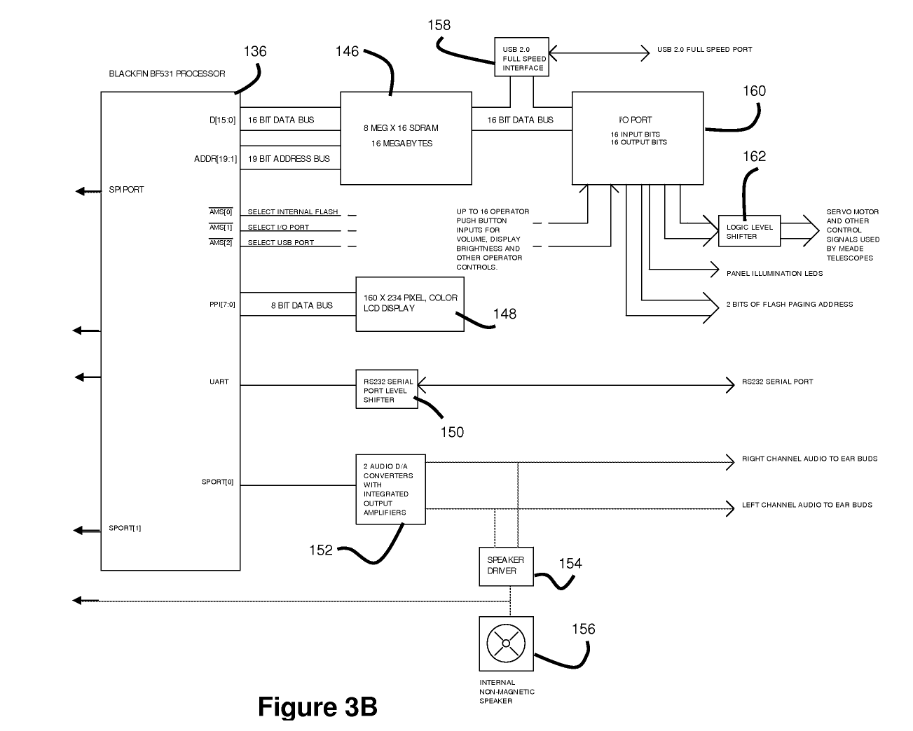

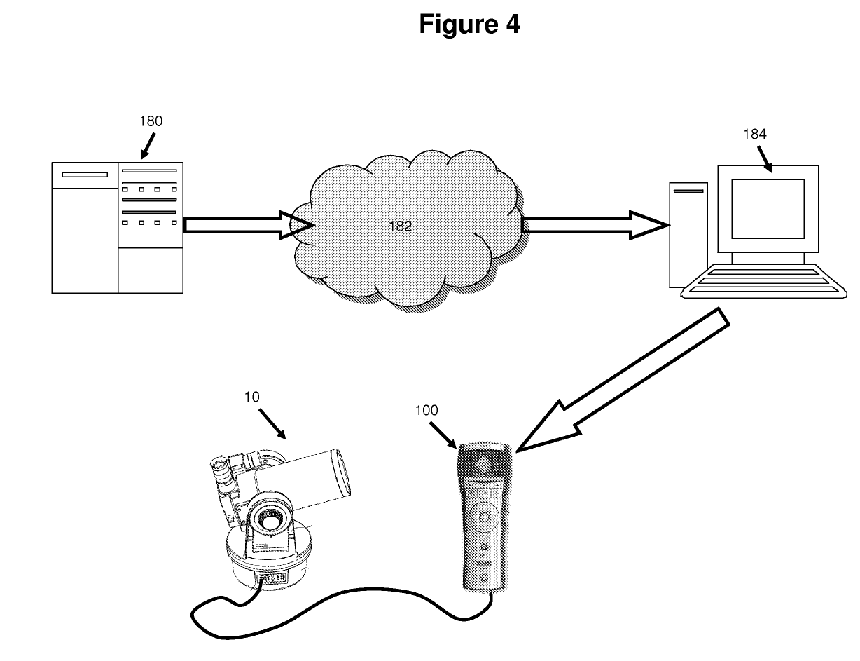

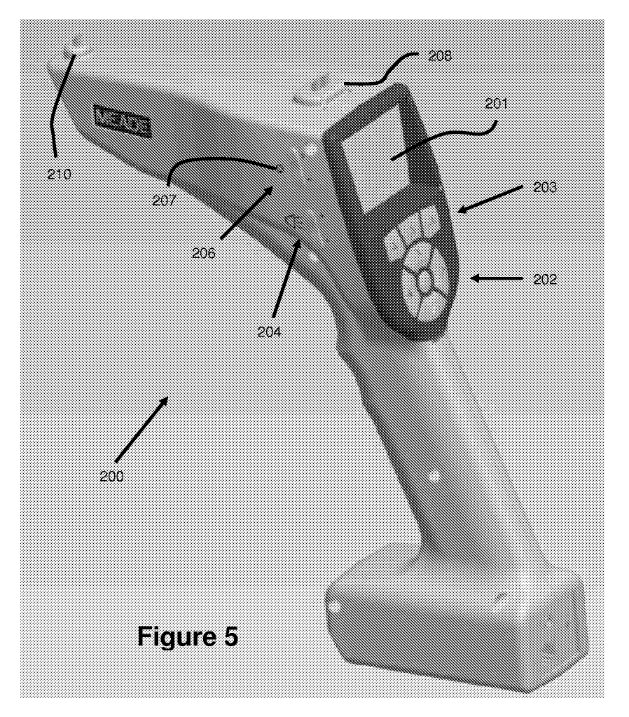

Referring to FIGS. 2A-2G, a preferred embodiment of the control unit 100 is illustrated according to the present invention for controlling the movement of the automated telescope system 10 while displaying video to a user. In this respect, the movement of the telescope system 10 can be coordinated or synced with the content of the video to provide the user with an enhance, multimedia experience.

In some respects, the control unit 100 is similar to previous control unit designs (e.g., those described in the previously incorporated patents or Meade Instruments Corporation's Autostar Computer Controller or Autostar II Computer Controller) in that the control unit 100 sends control signals over a cable 114 to the telescope system 10. Once received by the telescope system 10, the telescope tube 12 is moved to the position indicated by the control signal. Thus, once the telescope system 10 has been properly calibrated, the control unit 100 can direct the telescope to predetermined celestial objects or user-inputted coordinates.

As best seen in FIG. 2B, predetermined celestial objects may be selected by navigating a user menu displayed on the video screen 102 with multifunction buttons 104 or directional buttons 106. Manual control of the telescope tube 12 can be directed by the user with directional buttons 106, joystick 108 and speed switch 110. However, the buttons of the control unit 100 may also be context sensitive, having different functionality based on a selected mode of the control unit 100 or a user-specified functionality. For example, in one mode, the buttons may control the menu display and in another mode the buttons may control the manual movement of the telescope tube 12.

In addition to controlling the movements of the telescope system 10, the control unit 100 can play videos stored in a memory module (e.g., a SD memory card in an integrated card reader or integrated flash memory). As best seen in FIG. 2B, the multifunctional buttons 104 control playback of the video (e.g., play, pause, rewind fast-forward) while volume buttons 112 control the volume level produced by speaker 120 (seen in FIG. 2F) or through headphone port 118 (seen in FIG. 2E).

The video files may include telescope control data, either embedded within the video file or in an accompanying data file, which directs the telescope system 10 to view predetermined celestial locations during predetermined times of the video playback. Examples of this control data and its use can be seen in the patents previously incorporated by reference, such as U.S. Pat. No. 6,392,799.

In one example, the control data can be embedded into a data stream of an MPEG-4 file. As part of the MPEG-4 Part 14 standard, MPEG-4 files (e.g., files with a “.mp4” filename extension) may include almost any kind of embedded data stream in what are commonly referred to as “private streams” (e.g., Ahead Software's Vobsub DVD subtitle stream). In this respect, the telescope control data can be provided with time context information similar to that of DVD subtitles which allows the telescope control data to be executed by the control unit 100 (or possibly by the processor of the telescope 10) at a predetermined playback time (i.e., at a predetermined index time of the video and/or audio). Additional examples of common media container formats include 3GP, ASF, AVI, FLV, MXF, NUT, Ogg, Ogg Media, Quicktime and Realmedia. Examples of audio only media container formats may include AIFF, AU, WAV and MP3.

In another specific example, the audio and video may be included in an MPEG-2 format (e.g., files with a “.mpg” filename extension) and the telescope control data can be included in an ASCII text file containing a reference to the video file and the desired control data at a predetermined video time index. In this manner the control unit 100 can open the text file and load the control data into memory, then transmit appropriate control data to the telescope 10 as the control unit 100 plays through a specified time index of the video.

Additionally, file structures and formats may be used which allow the user to interact with the video file. For example, a specific video may include menus for allowing the user to select and play one of many different video clips. In another example, the control unit 100 may provide a video game that sends control signals to the telescope at predetermined times or at predetermined game events. In one example a file structure similar to those on a DVD (e.g., VIDEO_TS, VOB and IFO files) may be used. Thus, the control unit 100 and video file(s) may be used in a manner similar to a DVD player with a DVD (e.g., menus for different TV shows, chapters in a movie or menu-driven DVD games). In another example, a programming language such as Macromedia's Flash may be used to contain and play the video or provide a game that interacts with the telescope 10.

Preferably, the video files are stored in memory of the control unit 100, such as in internal memory or a flash memory card reader. In this respect, a user can copy data onto a flash memory card and insert the card into a card reader integrated within the control unit 100 or transfer data from a computer to the memory of the control unit 100 (e.g., by USB, Wifi or Bluetooth protocols). Optionally, the video may be stored remotely, such as on a remote personal computer, and accessed on demand through an appropriate communication protocol (e.g., Wifi or Bluetooth protocols).

In another preferred embodiment, the telescope control data can also or alternatively be synched with laser control data, allowing the telescope system 10 or the controller 100 to quickly move a laser to “draw” images on the sky. For example, a media file may direct the telescope 10 towards the stars of the constellation Orion while directing the laser to trace the shape of the hunter in the Orion constellation. Thus, different shapes or images may be displayed in the sky above the user and synched with the telescope and/or other media (e.g., video, audio, or pictures).

Preferably, a neodymium diode laser that emits a green beam at a wavelength of 532 nanometers is used, since the human eye is thought to be more sensitive to green wavelengths of light than red wavelengths of more common lasers. The “drawing” mechanism of the laser may be achieved, for example, by placing the laser on a motorized mechanism for movement in two dimensions or by directing the laser beam onto a gimbaled, motorized mirror. Additional details of such lasers for use in celestial applications can be seen in U.S. Publication Number 2005-0246911, the contents of which are hereby incorporated by reference.

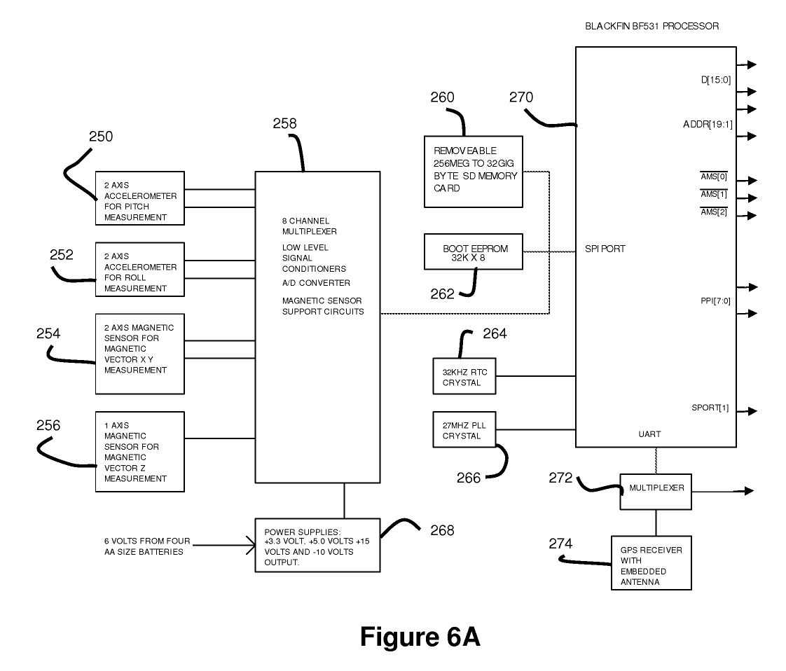

FIGS. 3A and 3B illustrate a schematic circuit diagram of a preferred embodiment of the control unit 100 according to the present invention. For clarity purposes, this diagram has been illustrated in FIG. 3A and continued in FIG. 3B.

Turning first to FIG. 3A, the control unit 100 includes a power supply 130 that is powered by 12 volts from eight AA size batteries or a similar rechargeable power supply. The power supply 130 preferably produces +3.3 volts, +5.0 volts, +15 volts and −10 volts which provide power to the different components of the control unit 100.

As previously discussed, the control unit 100 preferably includes a memory card reader 132 for reading data from a removable memory card, such as a flash memory card (e.g., an SD memory card) between 256 megabytes and 32 gigabytes in size.

Continuing with FIG. 3A, the control unit 100 also includes an integrated boot memory 134 that contains the appropriate configuration data for booting up the control unit 100. Preferably this boot memory 134 is EEPROM (Electronically Erasable Programmable Read-Only Memory), however other types of memory may alternatively be used.

As seen in both FIGS. 3A and 3B, the control unit 100 includes a CPU 136 which is responsible for much of the processing performed, such as video decoding (e.g., with a video codec), audio decoding, GPS processing, telescope coordinate calculations and calculations related to the positioning of the telescope 10 (e.g., Proportional Integral Differential (PID) calculations). One example processor chip that may be used is a Blackfin BF531 processor. Thus, the cost of producing a control unit 100 is reduced by using a single processor to process multiple types of data (as opposed to multiple, specialized processors for different computing tasks) and the overall circuit design of the unit 100 is simplified.

Returning to FIG. 3A, the control unit 100 maintains the current time and date, in part, with a 32 KHZ RTC crystal 138 (Real Time Clock Crystal). Similarly, a 27 MHZ PLL crystal 140 (Phase-Locked Loop crystal) is included for use in a phase-locked loop for the high speed internal clock of the CPU 136, allowing onboard software or firmware to adjust or scale the processor speed as needed, thereby minimizing power consumption.

Referring to FIG. 3B, the control unit 100 further comprises internal high speed memory such as 16 Megabytes of SDRAM which allows programs and other data to be accessed and written to during operation.

A personal computer can be connected to the control unit 100 via a USB interface 158, allowing access to the memory card reader 132 and any internal memory. USB drivers appropriate for a user's operating system may be used on the personal computer, allowing the control unit 100 to mount as a storage device similar to an external hard drive. In this respect, the user may copy media and data files from their computer to the control unit 100 natively through the operating system or with specialized transfer software (e.g., similar to Apple's Itunes software). It should be understood that other computer communication interfaces may also be used to communicate between a personal computer and the control unit 100. Some examples include Wifi, Blutooth, and Firewire.

Continuing with FIG. 3B, an I/O module 160 is connected to the data bus of the control unit 100, connecting various input or output devices such as the buttons 104, 106, 108, 110 and 112; illumination LEDs, and a logic level shifter 162 (for servo motors and other control signals used by the telescope).

The control unit 100 further includes a module 150 for interfacing data signals from the telescope 10 over the cable 114. For example, the module 150 may be an RS232 serial port level shifter for interfacing signals from an RS232 cable and port.

The video screen 102 is preferably composed of a low power color display 148 such as LCD or OLED. Preferably, the display 148 is sized to have a video aspect ratio common to TV, movies and other popular media (e.g., 4:3 or 16:9), thereby minimizing any aspect distortion or unused display pixels.

Continuing with FIG. 3B, the control unit 100 further includes an audio module 152 that includes two digital-to-audio converters with an integrated output amplifier. Thus, the audio module 152 provides a stereo audio signal to the headphone port 118 (FIG. 2E) or to the speaker driver 154 which drives the production of sound with the internal non-magnetic speaker 156.

In addition to playing back audio and video, the control unit 100 may also record audio to any of the internal memory 132 or 146 as well as to a personal computer via one of the previously discussed communications protocols (e.g., wifi or USB). In the present preferred embodiment, the speaker 156 can also be used as a microphone, delivering an audio signal to the microphone amplifier 142 (FIG. 3A) which is then converted to data by the audio-to-digital converter 144. Thus, the control unit 100 may record or provide voice recognition functionality for the videos, games or telescope 10 movement similar to voice dialing seen in many cell phones. For example the user may speak control commands into the control unit 100 such as “move left 3 degrees” or “show me the moon” allowing the unit 100 to process the command and reference it against a list of predetermined commands. Once the spoken command matched to one of the predetermined commands, the unit 100 executes that predetermined command.

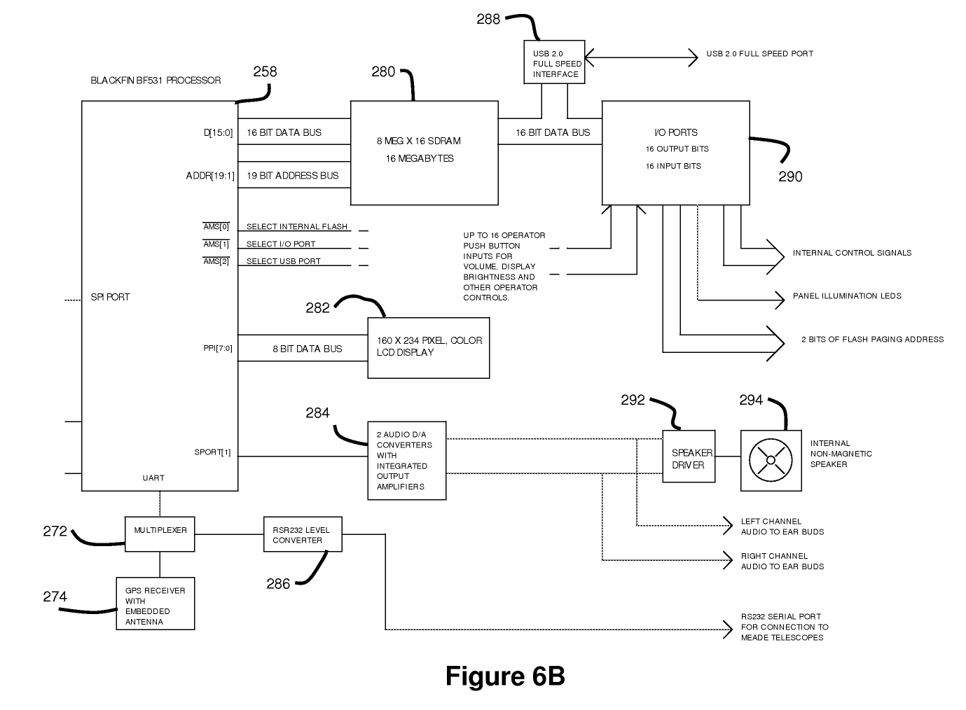

Turning now to FIG. 4, a preferred method of obtaining videos, games or other automated telescope media content for the control unit 100 is illustrated according to the present invention. The media content is stored on a server 180 which is connected to the internet 182. A user can operate a program on their personal computer 184 (e.g., a web browser, ftp software, bit torrent software or similar file transfer program) to select, optionally purchase and download desired media content. Once on the personal computer 184, the media can be transferred to the memory of the control unit 100, allowing the user to selectively play the media and thereby allow the media to direct movement of the telescope 10.

In operation, the user obtains a media file for an automated telescope system 10 by either creating a media file, copying the media file from a disc, downloading a media file from a remote server 180 (e.g., purchasing the media file) or streaming a media file from a server 180. Once at least partially located on the computer 184, the user can transfer or stream the media file to the control unit 100 where either the audio, video or both audio and video can be presented. Additionally, the synchronized telescope positional data is utilized, sending control commands to modify the position of the telescope 10 at the appropriate time during the media operation.

In this respect, the user can, for example, listen to audio “podcasts”, view an educational video, view a “setup” video to calibrate the telescope 10 or play a game; each of which while the telescope 10 moves to view a predetermined location at a synchronized time. In a further example, the user may play a game or instructional video where the control unit 100 may sense the position of the telescope 10. Thus, the game or other media content may quiz and score the user based on the user's ability to accurately find a celestial object.

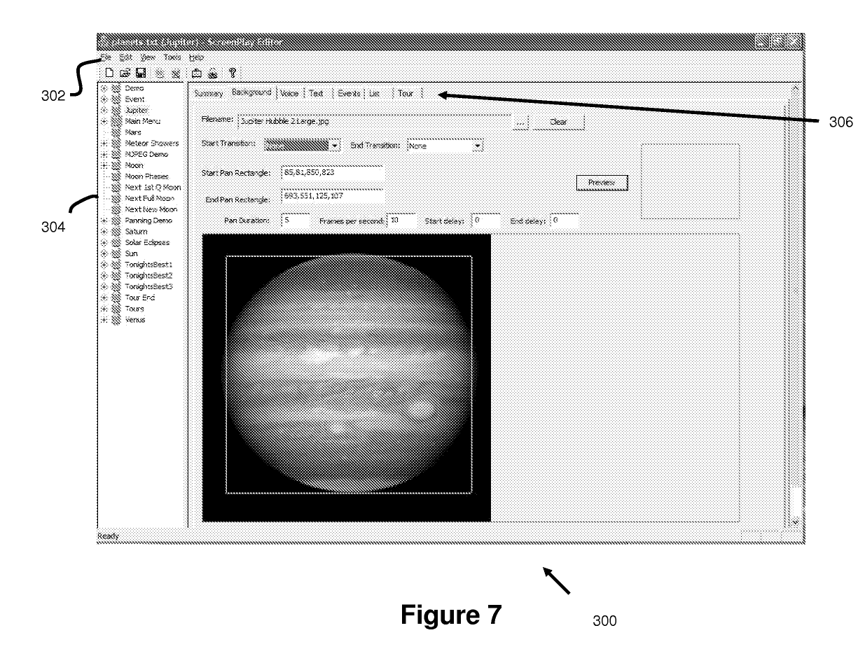

In another aspect of the present invention, other celestial observing devices may include some or even all of the previously described media functionality. One example device is a hand-held viewing device 200 that is illustrated in FIG. 5 according to a preferred embodiment of the present invention. As described in the previously incorporated U.S. Pat. No. 5,311,203 or seen in the Celestron SkyScout Hand-held Planetarium, the viewing device 200 automatically determines the three-dimensional direction in which it is pointing and automatically presents information to the user related to features which are visible in the field of view.

As Seen in FIG. 5, the user grasps the handle of the device 200, then aligns the front site member 210 and rear site member 208 with a celestial object of interest, similar to aiming a gun. The device 200 senses its orientation with circuitry described below, then appropriately utilizes this data, for example by displaying an image or video of the celestial object.

Similar to the previously described control unit 100, the device 200 includes a video display screen 201 for displaying media (e.g., graphics, videos, games, etc.). Playback of the media can be controlled with media buttons 203 while volume and contrast can be adjusted with buttons 204 and 206 respectively. To navigate an onboard menu system, directional buttons 202 can be operated by the user. Further, each of the buttons 202, 203, 204 and 206 may have context-sensitive functions that allow for multiple uses in different menus or use contexts.

The device 200 further includes a speaker (not shown) and a headphone port 207 that allows the user to hear the audio of the media. As with the control unit 100, the device may include a microphone or use the speaker for voice recognition or sound recording.

Unlike the telescope 10 of the previously described preferred embodiment, predetermined or synchronized data accompany the media will not cause a change in the orientation of the device 200. However, the device 200 may utilize this data to compare against a current orientation, then direct the user to a predetermined viewing orientation (i.e., direct the user to move up, down, left or right with on screen indicators). For example, during playback of a video about a certain star the device 200 compares the current device orientation to the orientation known to view the star, then directs the user with visual and/or audio cues to the viewing angle and direction appropriate to view the discussed star.

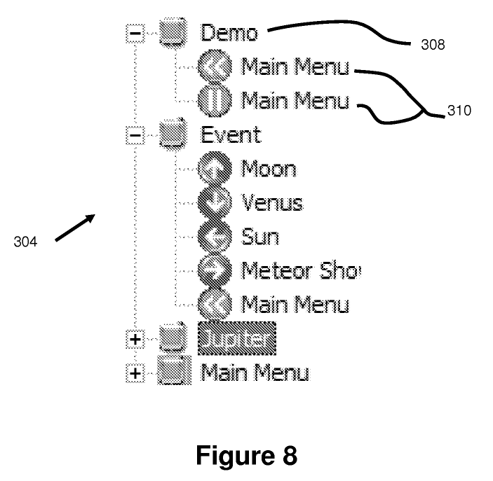

Referring now to FIGS. 6A and 6B, a preferred schematic circuit diagram of the device 200 is illustrated according to the present invention. For clarity purposes, this diagram has been broken up between FIG. 6A and FIG. 6B.

The orientation or direction sensing of the device 200 is achieved with accelerometer 250 and magnetic sensors 254 and 256. More specifically, the pitch of the device along two axes is measured by accelerometer 250. Further measurements of the device 200 with respect to the Earth's magnetic field in two X Y axes (e.g., roll) is measured with magnetic sensor 254 and in one Z axis with magnetic sensor 256. Each of these sensors 250, 252, 254 and 256 are connected to module 258 which conditions the signals, supports the magnetic sensors converts the analog sensor data to digital format and multiplexes the eight channels of data into a single data stream. Position data is obtained through a GPS receiver (or optionally by inputting a location or zip code), preferably including an embedded GPS antenna. Thus, the device 200 can determine its geographic location, pitch, roll and orientation relative to the Earth's magnetic field.

The remaining components within the circuit of the device 200 are generally similar to those of the previously described control unit 100. For example, a power supply 268 provides power, such as +3.3 volts, +5.0 volts, +15 volts and −10 volts, to the different components of the device 200. A memory card reader 260 is also included for reading data (such as media, executable programs or an operating system) from a removable memory card, such as a flash memory card. Additionally, integrated boot memory 262 such as EEPROM is included for storing configuration and boot data for the device 200.

The device 200 also similarly includes a 32 KHZ RTC crystal 264 (Real Time Clock Crystal) for maintaining the current time and date and a 27 MHZ PLL crystal 266 (Phase-Locked Loop crystal) to allow manipulation of the speed of a CPU 270.

As seen in both FIGS. 6A and 6B, the device 200 also similarly includes the CPU 270 (e.g., a Blackfin BF531 processor) that is responsible for much of the onboard processing, such as video decoding, audio decoding, GPS processing, voice recognition and calculating/determining the celestial objects in the field of view 213 of the device 200.

Turning to FIG. 6B, the module further includes internal high speed memory such as 16 Megabytes of SDRAM which allows programs and other data to be accessed and written to during operation.

A personal computer can be connected to the device 200 via a USB interface 288, allowing access to the memory card reader 260 and any internal memory. USB drivers appropriate for a user's operating system may be used on the personal computer, allowing the device 200 to mount as a storage device similar to an external hard drive. In this respect, the user may copy media and data files from their personal computer to the device 200 natively through the operating system or with specialized transfer software (e.g., similar to Apple's Itunes software). It should be understood that other computer communication interfaces may also be used to communicate between a personal computer and the device 200. Some examples include Wifi, Blutooth, and Firewire.

Continuing with FIG. 6B, an I/O module 290 is connected to the data bus of the device 200, connecting various input or output devices such as the buttons 202, 203, 204 and 206; and illumination LEDs.

The display screen 201 is preferably composed of a low power color display 148 such as LCD or OLED. Preferably, the display 148 is sized to have a video aspect ratio common to TV, movies and other popular media (e.g., 4:3 or 16:9), thereby minimizing any aspect distortion or unused display pixels.

Continuing with FIG. 6B, the device 200 further comprises an audio module 284 that includes two digital-to-audio converters with an integrated output amplifier. Thus, the audio module 284 provides a stereo audio signal to the headphone port 207 (FIG. 5) or to the speaker driver 292 which drives the production of sound with the internal non-magnetic speaker 294.

A module 286 is further included in the device 200 for interfacing data signals from other related equipment (e.g., telescopes, computers, cameras, etc.). For example, the module 286 may be an RS232 serial port level shifter for interfacing signals from an RS232 cable and port. Thus the user can use the device 200 similarly to the previously discussed control unit 100 with the telescope 10, except with the ability to manually control the telescope by pointing to a desired location. The module 286 and GPS receiver 278 are each connected to a multiplexer 276 which multiplexes data from each into a single data stream that ultimately is sent to the CPU 258.

Generally, the device 200 can obtain videos, games or other media with orientation data in a manner similar to the method described for the control unit 100, especially with regard to FIG. 4. That is, media content can be downloaded from a server to a personal computer, then transferred to device 200 where the user can selectively play or execute the media.

In operation, the user obtains a media file for the device 200 by either creating a media file, copying the media file from a disc, downloading a media file from a remote server or streaming a media file from a server. Once at least partially located on the personal computer, a transfer of the file can be automatically or manually initiated to the device 200 where the audio, video or both can be presented. Additionally, the synchronized orientation data (e.g., pitch, roll, position) is utilized, for example, directing the user to view a celestial object at a predetermined time during the media playback or sensing if the user is viewing a specified celestial object.

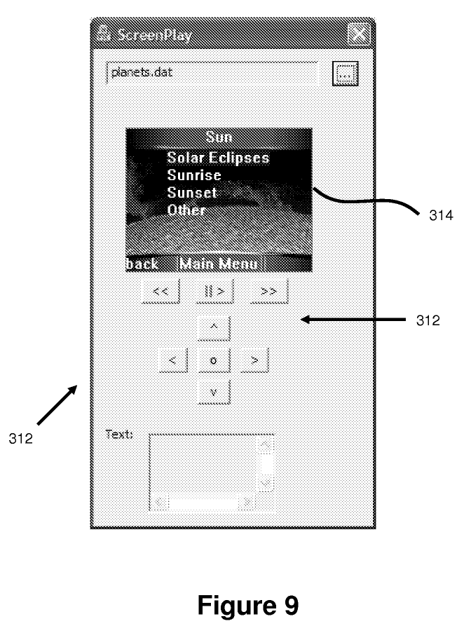

In another aspect of the present invention seen in FIGS. 7-9, software is provided for creating media with positioning or orientation data readable by the control unit 100 or the viewing device 200. In a preferred embodiment, the software provides a graphical user interface 300 (GUI) that allows a user to import bare media (i.e., media without position or orientation data such as pictures or video) and add such data at specific time indices (e.g., 2 minutes 32 seconds) or at particular media events (e.g., at menu selection or an event in a game). This position or orientation data can be saved as a separate data file or as a single file integrated with the media as discussed earlier in this specification.

As seen best in FIG. 7, the GUI 300 includes a pull-down menu for opening and saving files, selecting editing commands, viewing different interface windows, using software tools and reading a help file for the software.

The GUI 300 includes a navigation window 304 which displays a menu structure for a media file. As seen in the magnified view of FIG. 8, different menus 308 may include submenu selections 310. Each submenu selection can be associated with a key of control unit 100 or viewing device 200. In this respect the user can create a menu in which different buttons trigger different events (e.g., video or audio events).

Returning to FIG. 7, the events generated at different times during the media display can be added or modified with features of multiple tabbed pages 306. For example, the present GUI 300 includes tabbed pages 306 relating to background pictures or video, voice narration, on screen text, celestial events (i.e., celestial coordinates) and other similar creation features common to media creation. Other creation features may include simulated video through “panning” of a larger image, displaying successive smaller images from a larger source image, video import, and video effects.

Preferably, the software can validate the collection of menus 308, submenus 310 and their events to ensure that all are referenced by at least one other menu 308 and that all menus have at least one associated event to allow the transition to another menu.

As seen in FIG. 9, the user may also preview their media with a hardware simulator 312 which includes a preview screen 314 and simulated virtual buttons 312. In this respect, the user can quickly preview their media without the need to load it onto a control unit 100 or a viewing device 200.

It should be understood that different components of the embodiments described in this specification may be interchanged or used with different described embodiments. For example, the control device 100 may be used with the viewing device 200.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A method of controlling a motorized telescope comprising:
providing a motorized telescope;
playing a video on a device in communication with said motorized telescope;
reading telescope synchronization data associated with said video;
directing said motorized telescope to a first predetermined orientation based on said telescope synchronization data at a first time index of said video.

2. The method of claim 1, wherein said playing a video on a device in communication with said motorized telescope further comprises displaying said video on a display integrated with said motorized telescope.

3. The method of claim 1, wherein said playing a video on a device in communication with said motorized telescope further comprises displaying said video on a display distinct from said motorized telescope.

4. The method of claim 1, wherein said playing a video on a device in communication with said motorized telescope is preceded by transferring a media file to a memory located within said device.

5. The method of claim 1, wherein said reading telescope synchronization data associated with said video further comprises reading a predetermined video time index value and a predetermined telescope orientation value.

6. The method of claim 5, further comprising directing said motorized telescope to a second predetermined orientation based on said telescope synchronization data at a second time index of said video.

7. The method of claim 1, wherein said telescope synchronization data is embedded within said video.

8. The method of claim 1, wherein said telescope synchronization data is stored in a file distinct from a file containing said video.

9. The method of claim 1, wherein said playing a video on a device in communication with said motorized telescope further comprises playing a video selected from a group consisting of: an educational video, a telescope calibration video, a point-of-sale demonstration video and a video game.

10. A machine readable medium comprising telescope media data; said telescope media data comprising:
a media portion comprising data readable to display video on a display; and
a telescope synchronization portion comprising data for orienting an automated telescope at predetermined times relative to display of said video.

11. The machine readable medium of claim 10, wherein said media portion and said telescope synchronization portion are a single file.

12. The machine readable medium of claim 10, wherein said media portion further comprises data for displaying a menu on said display, said menu selectable to play a predetermined segment of said video.

13. The machine readable medium of claim 10, wherein said media portion further comprises data readable to produce audio.

14. The machine readable medium of claim 10, wherein said data for orienting an automated telescope further comprises a video index playback value associated with a telescope orientation value.

15. A machine readable medium comprising telescope media data; said telescope media data comprising:
a media portion comprising data readable to display a picture on a display; and
a telescope synchronization portion comprising data for orienting an automated telescope at predetermined times relative to display of said picture.

16. The machine readable medium of claim 15, wherein said media portion and said telescope synchronization portion are a single file.

17. The machine readable medium of claim 15, wherein said media portion further comprises data for displaying a menu on said display, said menu selectable to display a predetermined picture.

18. The machine readable medium of claim 15, wherein said media portion further comprises data readable to produce audio.

19. The machine readable medium of claim 15, wherein said data for orienting an automated telescope further comprises a time index value associated with a telescope orientation value.

20-56. (canceled)
